(19) United States
(12) Patent Application Publication
(10) Pub. No.: US 2023/0118030 A1
(43) Pub. Date: Apr. 20, 2023

(54) OPERATOR PROTECTION SYSTEM AND METHOD

(71) Applicant: Westinghouse Air Brake Technologies Corporation, Pittsburgh, PA (US)

(72) Inventors: Matthew McClory, Pittsburgh, PA (US); Pascal Martin, Rancho Palos Verdes, CA (US); Kelly Nichols, Quitman, TX (US); Jeffrey D. Kernwein, Cedar Rapids, IA (US); Andrew Ryan Staats, Cedar Rapids, IA (US); Stuart J. Barr, Cedar Rapids, IA (US)

(21) Appl. No.: 18/066,194

(22) Filed: Dec. 14, 2022

Related U.S. Application Data
(63) Continuation-in-part of application No. 16/841,296, filed on Apr. 6, 2020.
Application No. 16/841,296 is a continuation-in-part of application No. 15/726,446, filed on Oct. 6, 2017, now abandoned.
Application No. 15/726,446 is a continuation-in-part of application No. 16/802,286, filed on Feb. 26, 2020, now Pat. No. 11,558,906.
(60) Provisional application No. 62/406,144, filed on Oct. 10, 2016.

(51) Int. Cl. B60R 25/00; B60R 25/24

(52) U.S. Cl. CPC B60R 25/003; B60R 25/241

(57) ABSTRACT

A method includes receiving a request to assume control of a vehicle generated by a candidate operator via a first communication pathway. The method obtains a key from an onboard controller of the vehicle and communicates the key to the candidate operator via a second communication pathway that is different from the first communication pathway. The method determines the candidate operator to be a confirmed operator based at least in part on obtaining the key from the candidate operator via the first communication pathway.

### CROSS-REFERENCE TO RELATED APPLICATIONS

This application is a continuation-in-part of and claims priority to U.S. patent application Ser. No. 16/841,296 (filed 6 Apr. 2020), which is a continuation-in-part of and claims priority to U.S. patent application Ser. No. 15/726,446 (filed 6 Oct. 2017), which claims priority to U.S. Provisional Patent Application No. 62/406,144 (filed 10 Oct. 2016).

This application also is a continuation-in-part of and claims priority to U.S. patent application Ser. No. 16/802,286 (filed 26 Feb. 2020).

The entire disclosures of these applications are incorporated herein by reference.

### BACKGROUND

### Technical Field

The subject matter described herein relates to methods and systems for protecting an operator working in a vehicle network.

### Discussion of Art

The concept of a lock out, tag out system was introduced to reduce, and hopefully prevent, injury of a worker as the worker engages in an activity that would be much more hazardous if the equipment on which they are working is active, energized or moving. In theory, it places the ability to activate, energize or move the equipment solely in the hands of the at-risk worker. A common practice (which lends itself to the name) is for a worker to place a lock and/or tag on a control device that prevents operation until such lock or tag is removed; and no one but the operator should (or could, in the case of a lock) remove the protection and neither should they operate the machine with the lock/tag still in place. These traditional physical barriers to operation may not be sufficient for current systems due to, for example, their complexity or digital nature.

Vehicles in a vehicle network can operate according to dispatch systems that are designed to manage access to aspects of the vehicles and/or the systems in which the vehicles operate. These systems may seek to prevent to reduce risk-generating activities, such as vehicles accessing occupied sections of a route, unauthorized movement of the vehicles and/or to ensure that only certain operators have access to certain vehicles and/or vehicle components at certain times. Some of these systems may rely on databases that associate different authorized operators of the vehicles with different permissions related to control of the vehicle. Others may block access of vehicles to a section of a route until an operator, such as a route repairman, is clear of the route and sends a code back to central dispatch to confirm the same. Some conventional systems authenticate operators of vehicles by having the operator input a unique identification and password (one that is assigned only to the operator) into an onboard controller of a vehicle. Separately, the operator can communicate with a back office or dispatcher associated with a vehicle network to confirm their control of the vehicle.

Some conventional systems for authenticating operators on vehicles associated with vehicle networks may not provide adequate controls to prevent unauthorized operators from operating vehicles. For example, such systems do not implement controls for refusing to proceed with commands to move the vehicles based on unauthorized or falsely obtained access to onboard controllers of vehicles. Furthermore, some conventional systems may not adequately address potential problems of offboard operators controlling vehicles outside of permissions and/or schedules associated with the vehicles. In some cases, cybersecurity of the vehicle control may be compromised, or may merely be confused as to which vehicle is being commanded. Unauthorized or conflicting control of vehicles on vehicle networks may be undesirable.

In other current systems, a central dispatch may not use proper location information and may block access to an incorrect section of a route; or may de-energize the wrong item of equipment; or may allow unexpected movement of vehicles or expected movement of the wrong vehicles. In all, dispatch may make decisions and initiation undesirable actions for field workers. What may be desirable is a system and method that differs from those that are currently available.

### BRIEF DESCRIPTION

In accordance with one or more embodiments described herein, a method is provided that includes receiving a request to assume control of equipment generated by a candidate operator via a first communication pathway. At least a portion of a key is communicated to the candidate operator via a second communication pathway that is different from the first communication pathway, the key comprising a first key part. The candidate operator may be determined to be a confirmed operator based at least in part on obtaining the key from the candidate operator via the first communication pathway.

In accordance with one or more embodiments described herein, a system is provided that includes an offboard controller for communicating with one or more vehicles on a vehicle network and one or more processors configured to be coupled to one or more of the offboard controller. The controller may receive a request to assume control of a vehicle generated by a candidate operator via a first communication pathway, obtain a key from an onboard controller of the vehicle, communicate the key to the candidate operator via a second communication pathway that is different from the first communication pathway, and determine the candidate operator to be a confirmed operator based at least in part on obtaining the key from the candidate operator via the first communication pathway.

In accordance with an embodiment, a method is provided that includes determining that a candidate operator is a confirmed operator. The method transfers control of the equipment to the confirmed operator responsive to the determination that the candidate operator is the confirmed operator, and the confirmed operator is therefore enabled to initiate the equipment to perform one or more of the following: switching or securing one or both of an interlock and a crossing guard to prevent or block another vehicle from entering a section of a route, where the equipment is a wayside unit; engaging an emergency stop function to prevent the equipment from moving or from being moved, where the equipment is a vehicle, and the vehicle is or is not part of a vehicle group; and de-energizing electrical equipment, where the equipment is an electricity providing device.

In one embodiment, a system is provided that includes a controller. The controller can determine that a candidate operator is a confirmed operator and transfer control of the equipment to the confirmed operator responsive to the determination that the candidate operator is the confirmed operator. With that control, the confirmed operator may initiate the equipment to perform one or more of the following: switching or securing one or both of an interlock and a crossing guard to prevent or block another vehicle from entering a section of a route, where the equipment is a wayside unit; engaging an emergency stop function to prevent the equipment from moving or from being moved, where the equipment is a vehicle, and the vehicle is or is not part of a vehicle group; and de-energizing electrical equipment, where the equipment is an electricity providing device.

Optionally, where the equipment is a wayside unit that can control a route switch or interlock, the confirmed operator can configure or cause the switch or interlock to block or prevent another vehicle from entering a section of the route. Optionally, where the equipment is the vehicle, the confirmed operator can prevent the vehicle from moving, or the vehicle from being moved, or another vehicle from moving onto a co-located section of a route with the vehicle.

### BRIEF DESCRIPTION OF THE DRAWINGS

The inventive subject matter may be understood from reading the following description of non-limiting embodiments, with reference to the attached drawings:

FIG. 1 illustrates an example of a system for authenticating an operator in accordance with one or more embodiments described herein;

FIG. 2 illustrates an example vehicle network for implementing an operator authentication system in accordance with one or more embodiments described herein;

FIG. 3 illustrates an example of a communications network for implementing an operator authentication system in accordance with one or more embodiments described herein;

FIG. 4 illustrates a process for authenticating an operator in accordance with one or more embodiments described herein;

FIG. 5 illustrates a process for confirming an outgoing operator in accordance with one or more embodiments herein;

FIG. 6 illustrates a collection of communications for authenticating an operator in accordance with one or more embodiments described herein;

FIG. 7 is a diagram of a method in accordance with one or more embodiments described herein; and

FIG. 8 is a diagram of a method in accordance with one or more embodiments described herein.

### DETAILED DESCRIPTION

One or more embodiments of the inventive subject matter described herein provide for systems and methods that may authenticate operators of equipment. In accordance with an embodiment, a candidate operator may be determined to be a confirmed operator. There is a transfer of control of the equipment to the confirmed operator responsive to the determination that the candidate operator is the confirmed operator. With the control, the confirmed operator can initiate the equipment to perform one or more of the following: switching or securing one or both of an interlock and a crossing guard to prevent or block another vehicle from entering a section of a route, where the equipment is a wayside unit; engaging an emergency stop function to prevent the equipment from moving or from being moved, where the equipment is a vehicle, and the vehicle is or is not part of a vehicle group; and de-energizing electrical equipment, where the equipment is an electricity providing device.

As part of the confirmation process, the candidate operator, that is, the one who desires to be a confirmed operator, may initiate an exchange of information in order to validate their authenticity and their qualification to assume control over equipment. While there are several methods of verification possible, which can be selected based at least in part on application specific criteria, an example key is used for illustration of the feature. The one or more offboard controllers can, based on receiving a request, obtain a key from an onboard controller of one or more vehicles and communicate the key to the candidate controller over a second communication pathway that is different from the first communication pathway. The candidate controller, upon receiving the key over the second communication pathway, can communicate the key back to the one or more offboard controllers via the first communication pathway. Upon receiving the replayed and/or repeated key from the candidate controller over the first communication pathway, the one or more offboard controllers can determine the candidate operator to be a confirmed operator.

Determining the candidate operator to be a confirmed operator can include identifying, authenticating, and/or authorizing the candidate operator as a confirmed operator. The one or more offboard controllers can open a communication session between the confirmed operator and the one or more vehicles, permitting the confirmed operator to control the movements thereof. Accordingly, authenticating an operator may improve the security of vehicle networks by restricting access only to confirmed operators. Restricting access to confirmed operators can reduce or avoid unauthorized and/or conflicting control of vehicles among operators and/or among entities associated with vehicle networks, thereby improving the safety of vehicle networks.

During execution in one embodiment, the system may receive a request to assume control of equipment that is generated by a candidate operator via a first communication pathway. The system may communicate at least a portion of a key to the candidate operator via a second communication pathway that is different from the first communication pathway, the key comprising a first key part. The system may determine the candidate operator to be a confirmed operator based at least in part on obtaining the key from the candidate operator via the first communication pathway. Upon confirmation, the system may transfer control of the equipment to the confirmed operator. Optionally, the system may perform additional functions, such as notifying others of the change of control, re-routing vehicles in a manner that is responsive to control commands from the confirmed operator, changing the status of various items of equipment and/or sections of a route, and the like.

In one embodiment, the equipment may be a vehicle, and the vehicle may or may not be part of a vehicle group. The vehicle and/or vehicle group may be associated with one or more vehicle networks. One or more offboard controllers associated with a vehicle network may receive requests to assume control of one or more vehicles generated by candidate operators over a first communication pathway. In another embodiment, the equipment may be stationary, such as for power generation, energy storage or electrical transfer.

In embodiments where the equipment is a mobile vehicle or is a stationary wayside unit, and the system may obtain the first key part or a second key part from the wayside unit or from an onboard controller of the vehicle. These ‘key parts’ may refer to certain types of authentication systems, such as public/private keys and other forms of cryptographic security measures. Other suitable key parts may be a code from security fob, such as an RSA token. Yet other key parts may include a PIN or biometric data (a fingerprint), or a hash using the foregoing. Once confirmed, the system may respond by, for example, opening a communication channel between the equipment and the confirmed operator responsive to determining that the candidate operator is the confirmed operator, or transferring control to the operator's local device (smart phone, tablet, etc.), or may lock/unlock a compartment or a safety lock (coupled with other potential actions, such as de-energizing components, or ensuring that components are de-energized, or both). In one embodiment, a key part equivalent may include securing a block-chain authorization. This may be done, in one embodiment, as a bespoke ledger entry and in another embodiment as a micro-transaction added to, for example, a finance based crypto service (Bitcoin, Cardano, Ethereum, etc.).

The system may choose to open a communication channel with a device associated with the confirmed operator (such as a cell phone, tablet, etc.) or the confirmed operator may request it. In one embodiment, the first communication pathway is associated with a first type of communications network or a first type of communication protocol, and the second communication pathway is associated with a second type of communications network or a second type of communication protocol. That is, plural comm paths may be used to reduce the chance of improper confirmation of an operator. Additionally or optionally, the system may determine the candidate operator to be the confirmed operator based at least in part on one or more of an operator credential, a vehicle location, a wayside unit location, a vehicle operation schedule, an operator authority level, a security token, and biometric identification information. That is, the system may use plural data sources or types to ensure that the confirmation process is proper and correct. If, for example, the candidate operator's location is not the same location as the equipment, the system may deny the candidate as a confirmed one.

Should the selected authentication protocol fail, the system designates the candidate operator to be a denied operator. This may be done based at least in part on obtaining a different key or key part from the candidate operator via the first communication pathway. If denied, the system may respond with notifications, successive validation attempts, and/or the initiation of security and/or safety measures.

Once confirmed, the system may transfer control of the equipment to the confirmed operator, and the confirmed operator is then capable and enabled to initiate the equipment to perform an action. These actions may include one or more of: switching or securing one or both of an interlock and a crossing guard to prevent or block another vehicle from entering a section of a route, where the equipment is a wayside unit; engaging an emergency stop function to prevent the equipment from moving or from being moved, where the equipment is a vehicle, and the vehicle is or is not part of a vehicle group; and de-energizing electrical equipment, where the equipment is an electricity providing device.

In an embodiment where the equipment is a wayside unit, the transfer of control may signal a central authority that the section of the route is blocked, and the central authority does not and/or cannot direct another vehicle to enter the section of the route until the confirmed operator returns control over the equipment back to the central authority.

In an embodiment where the equipment is the electricity providing device, the system may facilitate access to an interior of the equipment by the confirmed operator. As part of that facilitation, the system may de-energize electrical components within the equipment, may test for residual power in energizable circuits, and/or may physically disconnect switches to allow relatively safer access to internal components. This, for example, may retract a catenary hook up even if electricity is not supposed to be flowing through the charging ports.

In one embodiment, a method is provided for determining that a candidate operator is a confirmed operator; transferring control of the equipment to the confirmed operator responsive to the determination that the candidate operator is the confirmed operator, and the confirmed operator being therefor enabled to initiate the equipment to perform one or more of the following: switching or securing one or both of an interlock and a crossing guard to prevent or block another vehicle from entering a section of a route, where the equipment is a wayside unit; engaging an emergency stop function to prevent the equipment from moving or from being moved, where the equipment is a vehicle, and the vehicle is or is not part of a vehicle group; and de-energizing electrical equipment, where the equipment is an electricity providing device.

Where the equipment is a wayside unit, the method may include signaling a central authority that the section of the route is blocked. The central authority does not and/or cannot direct another vehicle to enter the section of the route until the confirmed operator returns control over the equipment back to the central authority. However, the central authority can notify and signal the state of the route section, can re-route other vehicles responsive to the blockage, and the like. In one embodiment, a positive vehicle control system is notified, and a movement authority is suspended until control is returned. A suitable positive vehicle control system may be a Positive Train Control system, such as I-ETMS® that is commercially available from Wabtec Corporation.

If and when the confirmed operator has completed their tasks, they may return control of the equipment to the central authority from the confirmed operator. This may optionally include a second authentication protocol. In one embodiment, this may simply be the confirmed operator returning a code key provided to the confirmed operator at the time that control was provided. In a more robust and practical embodiment, no code key is provided for return of control.

In embodiments where the equipment is the vehicle, the confirmed operator can control the vehicle, which is not part of a vehicle group, to prevent or block movement of that vehicle. Where the vehicle is part of a vehicle group or consist, the confirmed operator can control the vehicle group, of which the vehicle is a part, to prevent or block movement of that vehicle group. That would naturally be inclusive of the vehicle.

In embodiments where the equipment is the electricity providing device the system can facilitate access to an interior of the equipment by the confirmed operator. Should the energy providing device be disposed on the vehicle, the confirmed operator can control the vehicle to prevent or block movement of that vehicle. While accessing the electricity providing device, such as for maintenance, repair, replacement and the like.

In one embodiment, a system includes a controller. The controller can determine that a candidate operator is a confirmed operator. Once authenticated as a confirmed operator, the system may transfer control of the equipment to the confirmed operator. With that control, the confirmed operator may initiate the equipment to perform one or more of the following: switching or securing one or both of an interlock and a crossing guard to prevent or block another vehicle from entering a section of a route, where the equipment is a wayside unit; engaging an emergency stop function to prevent the equipment from moving or from being moved, where the equipment is a vehicle, and the vehicle is or is not part of a vehicle group; and de-energizing electrical equipment, where the equipment is an electricity providing device.

In an embodiment where the equipment is a wayside unit for controlling a route switch or interlock, the confirmed operator can configure or manipulate the switch or interlock to block or prevent another vehicle from entering a section of the route. In an embodiment where the equipment is the vehicle, the confirmed operator can prevent the vehicle from moving or from being moved.

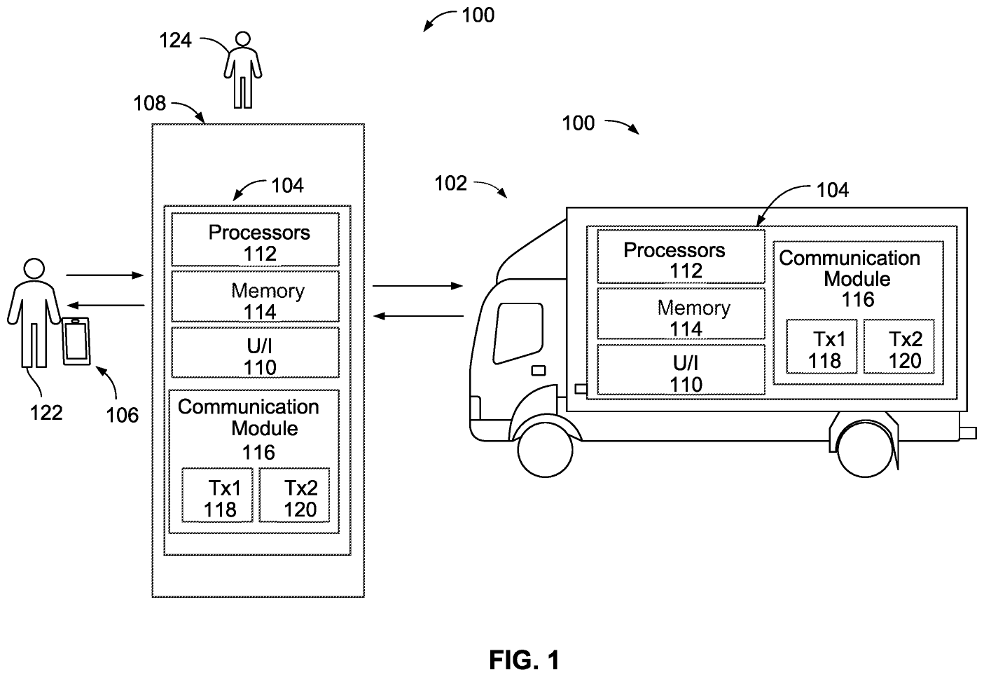

FIG. 1 is a diagram that illustrates an example of the system for authenticating an operator in accordance with one or more embodiments described herein. The system 100 may include a vehicle 102 with a controller 104 disposed onboard (an onboard controller) in communication with a second controller that may disposed offboard the vehicle (an offboard controller. With reference to offboard, this may include in a back office, another vehicle, in wayside equipment or dispatch agency associated with one or more vehicle networks. A controller includes hardware circuitry that includes and/or is operably coupled with one or more processors. Optionally, the system can be at least partially implemented in one or more node 106. A suitable node can be a device that can create, send and/or receive data or other signals, as discussed further herein.

The onboard controller can control operation of the vehicle. Among other things, the onboard controller can control operation of a propulsion system (not shown) that is onboard the vehicle. In the case of a consist (described herein), the onboard controller may generate control signals for, and/or receive control signals from, the other vehicles and/or offboard controller. The onboard controller includes and/or is operably coupled with one or more user interfaces 110, one or more processors 112, one or more non-transitive storage devices 114 (or memory), one or more communications modules 116, one or more sensors (not shown), and, optionally, one or more node. The one or more processors can include and/or represent one or more hardware circuits or circuitry that includes and/or is operably coupled with one or more computer processors (e.g., microprocessors) or other electronic logic-based devices.

Nodes can be associated with an operator 122 or a specific designated location 123. The offboard controller may be associated with a central authority, such as a dispatcher 124. The nodes may facilitate communication between the operator (or location) and the central authority. A suitable candidate operator or a current operator may be someone who interacts with equipment, directly or indirectly, and/or a physical location associated with the operator. The candidate operator has yet to be verified and designated a confirmed operator.

The term “vehicle” may refer to equipment for transporting or carrying one or more passengers and/or cargo. Suitable types of vehicles may include rail vehicles, automobiles, trucks, buses, trains (e.g., one or more locomotives and/or one or more rail cars coupled together), agricultural vehicles, mining vehicles, aircraft, industrial vehicles, and marine vessels. Vehicles may be manually operated, or automated or semi-automated. In one embodiment, vehicles include autonomous and semi-autonomous vehicles. Suitable rail vehicles may include locomotives, switchers, shunters, rail cars, tender cars, and Maintenance of Way (MoW) vehicles. The vehicle may be able to couple or connect with one or more other vehicles logically and/or mechanically, to form at least part of a consist, swarm, convoy, platoon, and the like—collectively a “consist.” As such, the term “consist,” refers to a vehicle group having two or more vehicles or items of mobile equipment that are mechanically or logically coupled to each other. By logically coupled, the plural items of mobile equipment can communicate with each other (e.g., by wireless command) to coordinate movements so the mobile equipment moves together. An Ethernet over multiple unit (eMU) system may include, for example, a communication system for use transmitting data from one vehicle to another in consist (e.g., an Ethernet network over which data is communicated between two or more vehicles). In one example of a consist, the vehicle can be a powered vehicle capable of propulsion to pull and/or push additional non-powered vehicles or other mobile equipment.

The offboard controller and, optionally, one or more of the nodes, can include and/or may be operably coupled with one or more user interfaces, one or more processors, one or more non-transitive storage devices (or memory), one or more communications modules, one or more sensors (not shown), and, optionally, one or more node.

In accordance with one or more embodiments described herein, the on-board controller and/or the offboard controller can implement the controller (e.g., a system including positive and/or negative control functionality). The controller may implement, in addition to or in lieu of positive controls, one or more of negative controls, open loop controls, closed loop controls, or the like. The onboard controller and/or the offboard controller can include a user interface. The user interface can include a display and/or operational controls. In one example, the on-board controller can be disposed in a cabin of a vehicle and may monitor the location and movement of the vehicle within a vehicle network. The cabin may house the operator in an automobile, in a lead vehicle of a consist, or the like. For example, the controller can enforce travel restrictions including movement authorities (e.g., generated by one or more offboard controllers) that prevent unwarranted movement of the vehicle (e.g., by unauthorized controllers and/or into certain route segments). Additionally or alternatively, the controller can allow the vehicle to enter certain route segments unless or until a signal from an off-board controller tells the vehicle to not enter into the segment. In this way, vehicle security can be increased and vehicle collisions, over speed accidents, incursions into work zones, and/or travel through improperly managed junctions among pathways can be reduced or prevented. As an example, the controller may command the propulsion system of the vehicle and, optionally, propulsion systems of one or more other vehicles, to slow or stop the vehicle (or consist), to increase the speed of the vehicle, to increase or decrease the elevation of the vehicle, to steer the vehicle left or right, and/or to activate a switch, and interlock, traffic signals, crossing gates, and the like. A slow order may be to comply with a speed restriction or a movement authority. In one embodiment, the controller may energize or de-energize electrical devices. Suitable electrical devices may include battery chargers, catenaries, third rails, energy storage devices, energy converters (generally from fuel to electricity), and the like. Suitable energy storage devices may include battery banks (inclusive of battery modules, battery packs, and battery cells), capacitors (inclusive of supercaps and ultracaps), and the like. In some embodiments, the electrical device may include fuel handling systems, particularly those that are on a fuel tender that has a reformer or regassification unit. Collectively, the energy converters, energy storage devices, and other electrical devices are referred to as electricity providing devices.

The controller, responsive to instructions stored in the memory, may control the system to authenticate an operator and/or control movement of the vehicle and/or control a propulsion system of the vehicle. Controlling movement of a vehicle may include whether a vehicle enters, or is blocked from entering, a section of a route. In one embodiment, the movement control may be simply controlling whether the vehicle is stationary or in motion. In one embodiment, the movement control may be simply controlling at what speed the vehicle is moving (that is, adjust the vehicle speed from a first speed to a different, second speed). In one embodiment, the movement control may be simply controlling whether the vehicle is moving forward or backward, and so on. With regard to controlling the propulsion system, the controller may prevent the operator from accessing certain interior volumes of the vehicle or may prevent the operator from accessing certain devices within the vehicle while the device is one determined state as opposed to another determined state; or, the controller may de-energize a device in response to the operator accessing or attempting to access the device.

In one embodiment, the confirmed operator may use the control afforded to him by the system to both access a de-energized section of a vehicle, prevent the vehicle from moving under its own power, and prevent a vehicle group (to which the vehicle is coupled) from moving and taking the target vehicle along with it.

In one embodiment, the one or more offboard controllers may receive requests to assume control of the vehicle generated by candidate operators over a first communication pathway, obtain security information from the onboard controller associated with the vehicle, such as a key. It may then communicate the key to candidate operators over a second communication pathway different from the first communication pathway and determine candidate operators to be confirmed operators based partially on obtaining the key from candidate operators via the first communication pathway. The first communication pathway and the second communication pathway can include one or more of different wireless networks, different communication media (e.g., EM waves, conductive pathways, PLCs, etc.) or different communication protocols.

A suitable key can be one or more of an encrypted key, a unique key, a cryptographic key, a private portion of a cryptographic key-pair associated with a registered identity, and the like, as described further below. The one or more onboard controllers may receive a request for a key, generate the key, and communicate the key to one or more offboard controllers associated with the vehicle network. The controller may determine candidate operators are to be treated as confirmed operators based at least in part on obtaining confirmation signals from the offboard controller indicating candidate operators to be confirmed operators prior to opening a secure communication channel with the candidate operators. The secure communication channel can be designed so that only authorized parties can exchange data. This may use a two-factor authentication system, biometrics, and the like. In one embodiment, the one or more onboard controllers and/or the one or more node may, among other things, receive the key over the second communication pathway and/or communicate the key to the candidate operator.

The communications module can provide one or more types of transceivers for communicating, among other things, keys over different communication pathways in accordance with one or more embodiments described herein. The different communication pathways can include one or more of different bands, different protocols, different communications networks, or the like. The controller may select one or more different communication pathways for communicating with operators and/or vehicles. In accordance with one or more embodiments herein, the one or more processors can select a first communication pathway for communicating with the vehicle and for receiving a key from a candidate operator and a second communication pathway for communicating the key to the candidate operator. In one embodiment, the first communication pathway can include any type of communications pathway suitable for establishing a secure communication session between a confirmed operator and the vehicle. The second communication pathway can include one or more of a different band than the band of the first communication pathway (e.g., different bands on a spectrum of bands, wireless and wired bands, intranet and internet bands, etc.), a different protocol than the protocol of the first communication pathway (e.g., Ethernet, controller area network bus, etc.), a different communications network than the first communication pathway (e.g., far field radio, near field radio, cellular, satellite, etc.), or the like. It will be appreciated that additional transceivers for different communication pathways may be provided or that one or more of the communications pathways discussed above may be omitted without departing from the scope of the inventive subject matter discussed herein.

In one embodiment, the node may be disposed onboard the vehicle, offboard and/or remote from the vehicle, accessible by a candidate operator, associated with a location of the candidate operator, viewable by the candidate operator, or the like. A node can may receive and/or communicate data or other signals indicative of a key. For example, the node can be one or more of a mobile communication device, a hardwired or wireless unit including sensors and/or a user interface that can be implemented in a location associated with one or more candidate operators (e.g., onboard the vehicle, at a centralized control center, etc.), a magnetic and/or radio frequency identification (RFID) badge, a dongle (e.g., implemented as a key fob, a badge, etc.), the onboard controller, or the like. Additionally or alternatively, the node can include and/or be coupled to one or more biometric sensors. The node may form part of an operator authentication system implemented as part of and/or in conjunction with one or more of the onboard controller and/or one or more offboard controllers.

The one or more node and/or the onboard controller associated with the vehicle may receive and/or communicate a key to a candidate operator via a second communication channel different from the first communication channel. In accordance with one or more embodiments described herein, the key can be communicated to the controller by the offboard controller in response to a candidate operator-generated request to assume control of the vehicle received at the offboard controller. For example, the candidate operator can access a user interface associated with one or more of the onboard controller and/or one or more node and select a button and/or execute a function to view a key transmitted by the offboard controller. Additionally or alternatively, the key can be contained in an encrypted format (e.g., an encrypted email, text, protected-access view of an application, or other communication) and the node can administer one or more challenges to authenticate the identity of the candidate operator in order to display the key. The one or more challenges can include and/or involve one or more of authentication information (e.g., user name, unique identity number, password, answer to a challenge question, etc.), presentation of an authentication item (e.g., a secure flash drive, an RFID badge, a dongle, or other data carrier coded with a unique identity number or the like), presentation of biometric information collected via one or more biometric sensors (e.g., fingerprint, eye, facial recognition, etc.), presentation of private key portions of key-pairs associated with a registered identity, or the like. Additionally or alternatively, the candidate operator may access a user interface implemented on a node (e.g., a personal mobile communications device, etc.) to execute a function to view a key.

The one or more processors may receive the key repeated by the candidate operator over the first communication pathway via one or more node and/or the onboard controller. Based on receiving the repeated key, the one or more processors can determine whether the candidate operator is an authorized operator. Based on determining the candidate operator to be a confirmed operator, the one or more processors can establish a secure communications session between the vehicle and the candidate (now confirmed) operator, thereby allowing the confirmed operator to control movements of the vehicle. Based on failing to determine the candidate operator to be a confirmed operator (e.g., by receiving a different key, or by otherwise failed credentials), the one or more processors can deny the candidate operator control of movement of the vehicle.

In one embodiment, the one or more processors can open a secure communication channel between the vehicle and the confirmed operator. In one embodiment, the second communication pathway can be associated with a type of communications network, a communication band, or a type of communication protocol that is different from the type of communications network, the communication band, or type of communication protocol associated with the first communication pathway. In one embodiment, the controller may determine the candidate operator to be the confirmed operator also based on one or more of an operator credential, a vehicle operation schedule, an operator authority level, or biometric identification information. In one embodiment, the controller may determine the candidate operator to be the confirmed operator also based on a current operator of the vehicle confirming relinquishing control of the vehicle. In one embodiment, the controller can obtain a second key part from the onboard controller, communicate the second key part to the current operator via the second communication pathway, and determine the current operator to be an outgoing operator based at least in part on obtaining the second key part from the current operator via the first communication pathway. In accordance with one or more embodiments herein, the controller can designate or determine the candidate operator to be the confirmed operator. This may be based on determining the candidate operator to be the only possible operator of the vehicle.

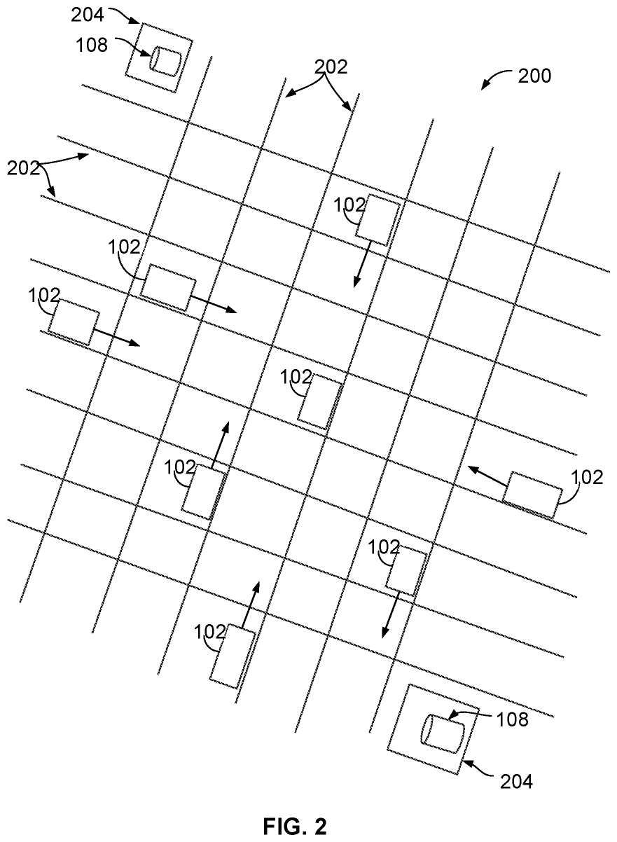

FIG. 2 is a diagram that illustrates an example vehicle network 200 for implementing an operator authentication system in accordance with one or more embodiments described herein. The terms “vehicle control network” and “vehicle network” shall mean a control network implemented among one or more vehicles and/or one or more offboard controllers. Vehicle networks are capable of communicating and/or implementing one or more of positive controls, negative controls, open loop controls, closed loop controls, or the like. Vehicle networks may be used to manage one or more of vehicles, types of vehicles, modes of transport, traffic on ways and/or paths, and the like associated with the vehicle networks. Vehicle networks may manage routes designed for one or more types of vehicles. Additionally or alternatively, vehicle networks may manage the same or different types of vehicles. Vehicle networks may exist in a static or dynamic geographic domain or among a select vehicle population. Vehicle control networks may also be formed on an ad-hoc basis between a plurality of vehicles. Operators associated with vehicle networks may control one, a portion of, or all of the vehicles associated with a given vehicle networks. Additionally or alternatively, operators associated with vehicle networks may control one, a portion of, or all of aspects of the vehicles associated with a given vehicle networks. Additionally or alternatively, operators associated with vehicle networks may include one or more autonomous controllers, AI controllers, or human controllers. Non-limiting examples of vehicle networks include vehicular ad hoc networks, positive vehicle control networks, negative vehicle control networks, closed loop vehicle control networks, open loop vehicle control networks, hybrid vehicle control networks, autonomous vehicle control networks, and the like.

The vehicle networks may include a plurality of routes 202. Suitable routes can be selected with reference to types of vehicles that may use the route. The terms “route,” “path” and “way” mean a road, waterway, air lane, track, and the like. The controller can request keys from one or more vehicles in the vehicle networks and one or more offboard controllers may control movement of at least the first vehicle and the one or more second vehicles, responsive to receiving one or more candidate operator-generated requests to assume control of one or more vehicles. In accordance with one or more embodiments, one or more of the routes, one or more of the vehicles, one or more of the controllers, or one or more of the wayside locations 204 may be subject to the control of (e.g., owned by, operated by, governed by, etc.) different entities. For example, a first wayside location may be owned by a first entity and a second wayside location may be owned by a second entity. Additionally or alternatively, all or a portion of the routes can be subject to the control of a first entity, all or a portion of the wayside locations can be subject to the control of a second entity different from the first entity, and all or a portion of the vehicles can be subject to control of a third entity different from one or more of the first entity and the second entity.

The one or more offboard controllers may be implemented remotely (e.g., a remote office, a virtual office, or one or more remote servers or the like) or at one or more wayside locations in the vehicle networks. Wayside locations may embody different devices located along routes. Non-limiting examples of devices implemented at wayside locations include signaling devices, switching devices, communication devices, etc. The wayside locations can include offboard controllers. In one example, the offboard controllers authenticate operators and/or provide travel information to the vehicles operating in the vehicle networks. Wayside locations can also include wireless access points that enable appropriately equipped vehicles in range to connect to one or more radio and/or wireless networks associated with the vehicle networks. The onboard controller, one or more node, or one or more communication modules onboard the vehicles of the vehicle network can dynamically establish network sessions with available radio and/or wireless networks through such devices implemented at wayside locations to relay data communication between vehicles of the vehicle networks and/or one or more offboard controllers 208 associated with the vehicle networks.

In accordance with one or more embodiments herein, a candidate operator can communicate a request to assume control of a vehicle via a first communication pathway. The request to assume control of the vehicle can be generated by a candidate operator accessing the user interface of the onboard controller and/or the node. The candidate operator can select an operator authentication function at the user interface operably coupled to the onboard controller and/or the node. For example, the candidate operator can access a user interface associated with the onboard controller and/or the node (e.g., a personal mobile communications device, a wired terminal, or a wireless terminal, etc.).

Upon receiving a candidate operator-generated request to assume control of a vehicle over a first communication pathway, the controller of the offboard controller can obtain a key from the onboard controller of the vehicle. The key can be generated by a key generator implemented in and/or can be operably coupled to the onboard controller. They key generator may generate random and/or secure keys. Additionally or alternatively, the key can be encrypted and/or retrieved from the storage medium by the controller of the onboard controller. The onboard controller can communicate the key to one or more offboard controllers via the first communication pathway. The one or more offboard controllers can communicate the key to the candidate operator via a second communication pathway that is different from the first communication pathway.

Based on the one or more offboard controllers communicating the key via the second communication pathway, the candidate operator can access a user interface associated with one or more of the onboard controller and/or one or more node to view the key and communicate the key to one or more offboard controllers via the first communication pathway or another communication pathway different from the second communication pathway. Additionally or alternatively, the candidate operator can execute a function (e.g., by selecting a button, etc.) to view a key transmitted by the offboard controller. The key can be communicated in an encrypted format (e.g., an encrypted email, text, protected-access view of an application, or other communication) and/or the onboard controller or the node can administer a challenge to authenticate the identity of the candidate operator in order to display the key.

The candidate operator can communicate the key to one or more offboard controllers using the first communication pathway. For example, the candidate operator can input and/or communicate the key by selecting one or more buttons and/or functions presented at the user interface of the onboard controller and/or the node 206 and execute a function to transmit the key to the offboard controller. Additionally or alternatively, the candidate operator can communicate the key to one or more offboard controllers using a communication pathway that is different from and/or adjunct to the first communication pathway. For example, the candidate operator can place a phone call to the dispatcher associated with the one or more offboard controllers (e.g., an AI dispatcher, a live dispatcher, or an automated dispatcher) and communicate the key either verbally and/or by a series of coded and/or audible tones.

The one or more offboard controllers can determine the candidate operator to be a confirmed operator based at least in part on obtaining the key from the candidate operator. The one or more offboard controllers can identify, authenticate, and/or authorize a candidate operator as a confirmed operator at least in part by comparing the key communicated by the candidate operator with the key received from the onboard controller of the vehicle. For example, the one or more offboard controllers can determine whether the key communicated by the candidate operator is identical to the key received from the onboard controller. The one or more offboard controllers can also identify, authenticate, and/or authorize a candidate operator as a confirmed operator based at least in part on one or more of an operator credential, a vehicle operation schedule, an operator authority level, or biometric identification information. For example, the one or more offboard controllers can compare the identity of the candidate operator to a list of authorized operators and/or a schedule of authorized operators to verify that the candidate operator has the requisite permissions to control the vehicle and/or is scheduled to control the vehicle at the time of the request. Additionally or alternatively, the key communicated by the candidate operator can include a first key portion that can be combined with a second key part portion to identify, authenticate, and/or authorize the candidate operator as a confirmed operator. For example, the first key portion can be a private key portion and the second key part portion can be a public key portion. The first and second key part portions can include one or more key-pairs that correspond to identity-related attributes associated with the candidate operator (e.g., operator credentials, biometric identification information, etc.), a vehicle operation schedule, an operator authority level, or the like.

Based on determining the candidate operator to be a confirmed operator, the one or more offboard controllers can allow the confirmed operator to control movement of the vehicle. Additionally or alternatively, the one or more offboard controllers can open a secure communication channel between the vehicle and the confirmed operator. Opening a communication channel can include establishing a vehicle session between the vehicle and the confirmed operator. During the vehicle communication session, the confirmed operator can control movement of one or more vehicles or groups of vehicles associated with the vehicle networks. The one or more offboard controllers can determine the candidate operator to be a denied operator based at least in part on obtaining a different key than the key from the candidate operator necessary to identify, authenticate, and/or authorize the candidate operator. Based on determining that the key communicated by the candidate operator does not match the key received from the onboard controller, the one or more offboard controllers can determine the candidate operator to be a denied operator and deny the candidate operator the ability to control movement of the vehicle.

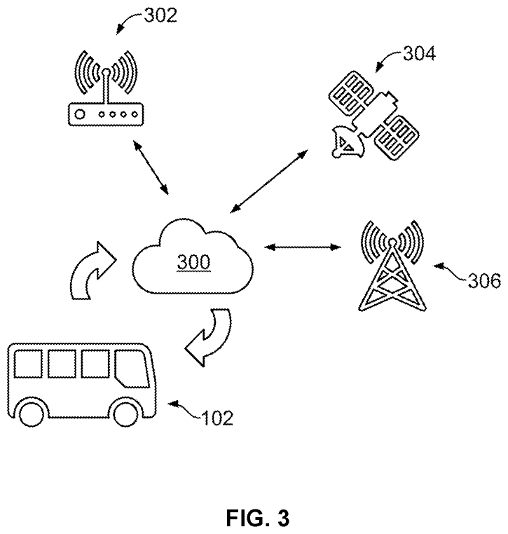

FIG. 3 illustrates a block diagram of an example of a communications network 300 for authenticating an operator in accordance with one or more embodiments described herein. The communications network can include one or more of a wireless network 302, a satellite network 304, or a radio network 306. The onboard controller(s) and the offboard controller(s) on the vehicle networks can include, as part of the communication module, one or more of a wireless transceiver, a satellite transceiver, or a radio transceiver. The wireless transceivers, satellite transceivers, or radio transceivers may be implemented as part of one or more of the onboard controller, the offboard controller, and/or one or more node that may be coupled to the onboard controller and/or the offboard controller.

The wireless network may be a cellular network and/or a mesh network, and may have plural wireless access points. These points may cover (or define) different travel zones (possibly with some overlap). As the vehicles travel through different travel zones, a wireless network device onboard the vehicles can detect different wireless network access points. These points may be provided by one or more wayside devices 210, cell towers, or other communication devices disposed along the routes of the vehicle networks. In one example, a single one of the wireless networks may define and/or cover a travel territory, and different wayside devices provide access points to the wireless network. Non-limiting examples of protocols that wireless network devices follow to connect to the wireless network may use IEEE 802.11, Wi-Max, Wi-Fi, and the like. In one example, the wireless network communications operate around the 220 MHz frequency band. By relaying vehicle data communications through the wireless network, communications, including operator authentication communications, can be made more reliable, especially in conditions where direct radio communication can be lost.

The vehicle (or the node) may transmit and receive data communications relayed through one or more satellites via satellite transceivers implemented as part of the onboard controller, the offboard controller, one or more node. In one example, a satellite transceiver can receive vehicle location information from a third-party global position system to determine the location of the respective vehicle. The vehicles can communicate directly with one or more offboard controllers associated with the vehicle networks.

The radio frequency (RF) network may use RF communications towers and RF repeaters. The vehicles can transmit and receive RF data communications relayed through one or more RF communications networks via radio transceivers operably coupled to the onboard controller, the offboard controller, and one or more node. In some embodiments, an RF transceiver includes a cellular radio transceiver (e.g., cellular telephone module) that enables a cellular communication pathway. In one example, the cellular radio transceiver communicates with cellular telephony towers located proximate to the routes of the vehicle networks. For example, radio transceivers may enable data communications between the vehicles, the node, and the offboard controller through a third-party cellular provider. Additionally or alternatively, radio transceivers enable data communication between the vehicles and a remote office associated with the vehicle networks and/or the one or more offboard controllers through a third-party cellular provider.

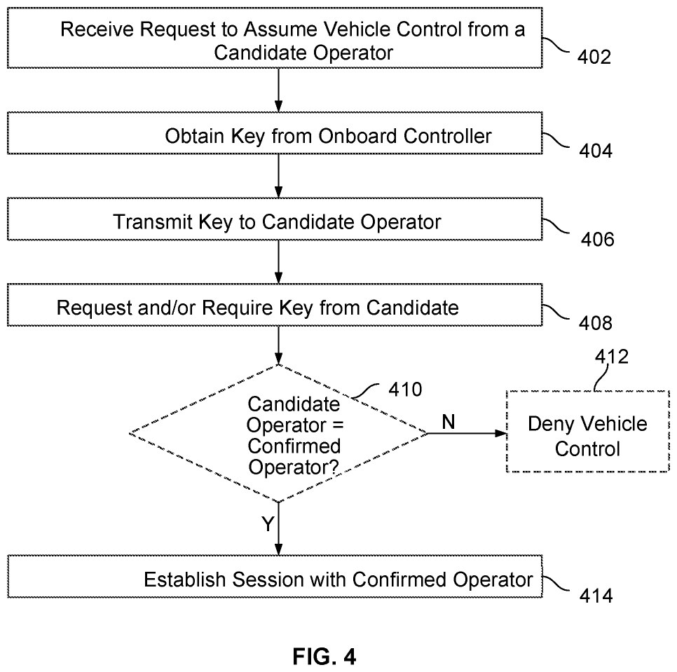

FIG. 4 illustrates an example process 400 for authenticating an operator in accordance with one or more embodiments described herein. The operations of FIG. 4 are carried out by one or more processors in response to execution of program instructions, such as in applications stored in the storage medium (or memory) implemented on one or more of an onboard controller, one or more offboard controllers, or one or more node. Optionally, all or a portion of the operations of FIG. 4 may be carried out without program instructions, such as in a key generator implemented in or operably coupled to the onboard controller of the vehicle that has the corresponding operations implemented in silicon gates and other hardware. The operations of the method are described in a somewhat serial manner, one or more of the operations of the method may be continuous and/or performed in parallel with one another and/or other operations of the one or more node, the one or more offboard controllers, and/or the onboard controller.

At step 402, the controller may receive a request to assume control of a vehicle generated by a candidate operator via a first communication pathway. The first communication pathway can be suitable for establishing a secure communication session between a confirmed operator and the vehicle. The request to assume control of the vehicle can be generated based on the candidate operator accessing the user interface of the onboard controller and/or the node. The candidate operator can execute an operator authentication function at the user interface operably coupled to the onboard controller and/or the node. For example, the candidate operator can access a user interface coupled to the onboard controller (e.g., at a terminal) and/or the node (e.g., a personal mobile communications device, a wired terminal, or a wireless terminal, etc.) and select a button to execute the operator authentication function to communicate the request to assume control of the vehicle to the one or more offboard controllers. Based on the controller receiving the request to assume control of the vehicle, the process continues.

At step 404, the controller may obtain a key from an onboard controller of the vehicle. The controller can obtain the key from the onboard controller by communicating a request to and receiving the key from the onboard controller over the first communication pathway. The key can be one or more of an encrypted key, a unique key, a cryptographic key, a private portion of a cryptographic key-pair associated with a registered identity, and the like as discussed further below. The key can include a plurality of one or more of letters, numbers, or symbols. The key can be generated by a key generator implemented in and/or may be operably coupled to the onboard controller. Optionally, the key can be randomly generated by the key generator. Additionally or alternatively, the key can be encrypted and/or retrieved from the storage medium by the controller of the onboard controller. Additionally or alternatively, the key can include a first key portion that can be combined with a second key part portion accessible by the one or more offboard controllers. Additionally or alternatively, the onboard controller can communicate the key to one or more offboard controllers via a communication pathway different from the first and second communication pathways.

At step 406, the controller may communicate the key to the candidate operator via a second communication pathway that is different from the first communication pathway. The controller can communicate they key to the candidate operator at a node accessible by the candidate operator. A node can be a device that is, among other things, operable to receive and/or communicate data or other signals indicative of a key. The node can be onboard the vehicle, offboard and/or remote from the vehicle, accessible by a candidate operator, associated with a location of the candidate operator, viewable by the candidate operator, or the like. Examples of node include mobile communications devices (e.g., smartphones, pagers, etc.), magnetic and/or radio frequency identification (RFID) badges, dongles (e.g., implemented as a key fob or the like), the onboard controller, or other hardwired or wireless units including sensors and/or a user interface that may be implemented in a location associated with one or more candidate operators (e.g., at a centralized control center or the like). The second communication pathway can include one or more of a different band than the band of the first communication pathway (e.g., different bands on a spectrum of bands, wireless and wired bands, intranet and internet bands, etc.), a different protocol than the protocol of the first communication pathway (e.g., Ethernet, controller area network bus, etc.), a different communications network than the first communication pathway (e.g., far field radio, near field radio, cellular, satellite, etc.), or the like. The candidate operator can access a user interface associated with the node and execute a function (e.g., select a button) to access the key transmitted by the offboard controller. Additionally or alternatively, the key can be contained in an encrypted format (e.g., an encrypted email, text, protected-access view of an application, or other communication) and/or the node can administer one or more challenges to authenticate the identity of the candidate operator in order to allow the candidate operator to access the key. The one or more challenges can include, for example and without limitation, presenting authentication information unique to the candidate operator, presenting an authentication item (e.g., an RFID badge, a dongle, etc.), presentation of biometric information to one or more biometric sensors integral with and/or operably coupled to the node, presentation of a first key portion of a key pair (e.g., a key pair including a private key portion and a public key portion associated with a registered identity), or the like.

At step 408, the controller may request and/or require the candidate operator to communicate the key to the controller over the first communication path. The candidate operator can communicate the key by verbally repeating and/or manually inputting the key into a field of a user interface of the node and/or the onboard controller. Additionally or alternatively, the candidate operator can communicate the key over a different communication channel than the second communication channel. For example, the candidate operator can place a phone call to and verbally repeat or input the key to a live, automated, and or AI dispatcher associated with one or more offboard controllers and/or current controller associated with the onboard controller. Additionally or alternatively, the candidate operator can execute a function to cause the key delivered via the second communication pathway to be communicated over the first communication pathway to the one or more offboard controllers.

At step 410, the controller may determine whether the candidate operator is a confirmed operator based at least in part on obtaining the key from the candidate operator via the first communication pathway. Determining the candidate operator to be a confirmed operator can include identifying, authenticating, and/or authorizing the candidate operator as a confirmed operator. The one or more offboard controllers can identify, authenticate, and/or authorize a candidate operator as a confirmed operator at least in part by comparing the key communicated by the candidate operator with the key received from the onboard controller of the vehicle to determine if the received keys match. The one or more offboard controllers can also identify, authenticate, and/or authorize a candidate operator as a confirmed operator based on one or more of an operator credential, a vehicle operation schedule, an operator authority level, or biometric identification information. For example, the one or more offboard controllers can compare the identity of the candidate operator to a list of authorized operators and/or a schedule of authorized operators to verify that the candidate operator has the requisite permissions to control the vehicle and/or is scheduled to control the vehicle at the time of the request. Additionally or alternatively, the key communicated by the candidate operator can include a first key portion that can be combined with a second key part portion to identify, authenticate, and/or authorize the candidate operator as a confirmed operator. For example, the first key portion can be a private key portion and the second key part portion can be a public key portion of a registered identity. The first and second key part portions can include one or more identity-related attributes associated with the candidate operator (e.g., operator credentials, biometric identification information, etc.), vehicle operation schedules, an operator authority level, or the like. Based on failing to determine the candidate operator to be a confirmed operator, flow branches to step 412. Based on determining the candidate operator to be a confirmed operator, flow branches to step 414.

At step 412, the controller may deny the candidate operator control of the vehicle or access to a compartment thereof, or control over equipment related thereto. The process can determine the candidate operator to be a denied operator based at least in part on obtaining a different key than the key from the candidate operator necessary to identify, authenticate, and/or authorize the candidate operator. Based on determining that the key communicated by the candidate operator does not correspond to the key received from the onboard controller, process can determine the candidate operator to be a denied operator and deny the candidate operator the ability to control movement of the vehicle, thereby ending and/or resetting the process.

At step 414, the controller may open a communication channel between the vehicle and the confirmed operator. Opening a communication channel between the vehicle and the confirmed operator includes permitting the confirmed operator to control movement of the vehicle and, optionally, additional vehicles associated with the vehicle networks. The communication channel can be a secure communication channel. Opening a communication channel can include establishing a vehicle session between one or more vehicles and the confirmed operator. During the vehicle communication session, the confirmed operator can control movement of one or more vehicles or groups of vehicles associated with the vehicle networks. Accordingly, operator authentication is provided to prevent unauthorize and/or conflicting control of vehicles on a vehicle network.

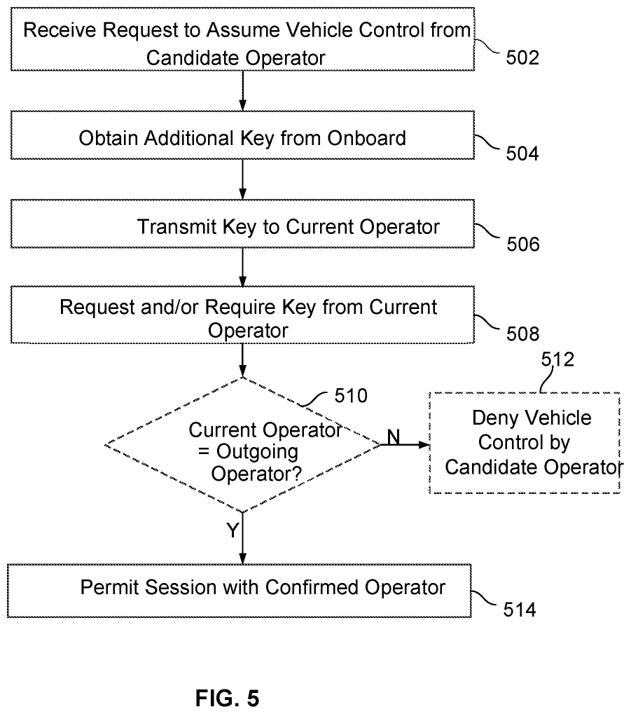

FIG. 5 is a flow chart that illustrates a process 500 for confirming an outgoing operator in accordance with one or more embodiments herein. The operations of FIG. 5 are carried out by one or more processors in response to execution of program instructions, such as in applications stored in the storage medium (or memory) implemented on one or more of an onboard controller, one or more offboard controllers, or one or more node. Optionally, all or a portion of the operations of FIG. 5 may be carried out without program instructions, such as in a key generator implemented in or operably coupled to the onboard controller of the vehicle that has the corresponding operations implemented in silicon gates and other hardware. The operations of the method are described in a somewhat serial manner, one or more of the operations of the method may be continuous and/or performed in parallel with one another, the operations of FIG. 4, and/or other operations of the one or more node, the one or more offboard controllers, and/or the onboard controller.

At step 502, the controller may receive a request to assume control of a vehicle generated by a candidate operator via a first communication pathway as described in operation 402 of the method of FIG. 4.

At step 504, the controller may obtain an additional or second key part from an onboard controller of the vehicle as described in operation 404 of method 400.

At step 506, the controller may communicate the key to a current operator via a second communication pathway that is different from the first communication pathway as described in operation 506 of the method of FIG. 4.

At step 508, the controller may request and/or require the current operator to communicate the key to the controller over the first communication pathway as described in operation 408 of the method shown in FIG. 4.

At step 510, the controller may determine whether the current operator is an outgoing operator based at least in part on obtaining the key from the current operator via the first communication pathway as described in operation 410 of the method shown in FIG. 4. Determining the current operator to be an outgoing operator can include identifying, authenticating, and/or authorizing the current operator as an outgoing operator. Determining the current operator to be an outgoing operator can be part of or precedent to determining the candidate operator to be a confirmed operator in operation 410 of the method shown in FIG. 4. Based on failing to determine the current operator is an outgoing operator, flow moves to step 512 and the process denies control of movement of the vehicle by the candidate operator. Based on determining that the current operator is an outgoing operator, flow moves to step 514 and the process permits establishment of a communication session between the confirmed operator (if the candidate operator is determined to be a confirmed operator at operation 410 of the method shown in FIG. 4, for example).

In one embodiment, the methods described herein can include determining the candidate operator to be a denied operator based at least in part on obtaining a different key than the key from the candidate operator via the first communication pathway. In one embodiment, the first communication pathway can operate in a first band and the second communication pathway can operate in a second band that is different from the first band. In one embodiment, the first communication pathway can be associated with a first type of communications network or a first type of communication protocol, and the second communication pathway can be associated with a second type of communications network or a second type of communication protocol. In one embodiment, the key can be communicated to an onboard location associated with the candidate operator. In one embodiment, the key can be communicated to an offboard location associated with the candidate operator. In one embodiment, the methods described herein can include determining the candidate operator to be the confirmed operator is based at least in part on one or more of an operator credential, a vehicle operation schedule, an operator authority level, and biometric identification information.

In one embodiment, the key can be a first key, and the methods described herein can include obtaining a different, second key part from the onboard controller, communicating the second key part to a current operator of the vehicle via the second communication pathway, determining the current operator to be an outgoing operator based at least in part on obtaining the second key part from the current operator via the first communication pathway; and determining the candidate operator to be the confirmed operator also based on determining the current operator to be the outgoing operator.

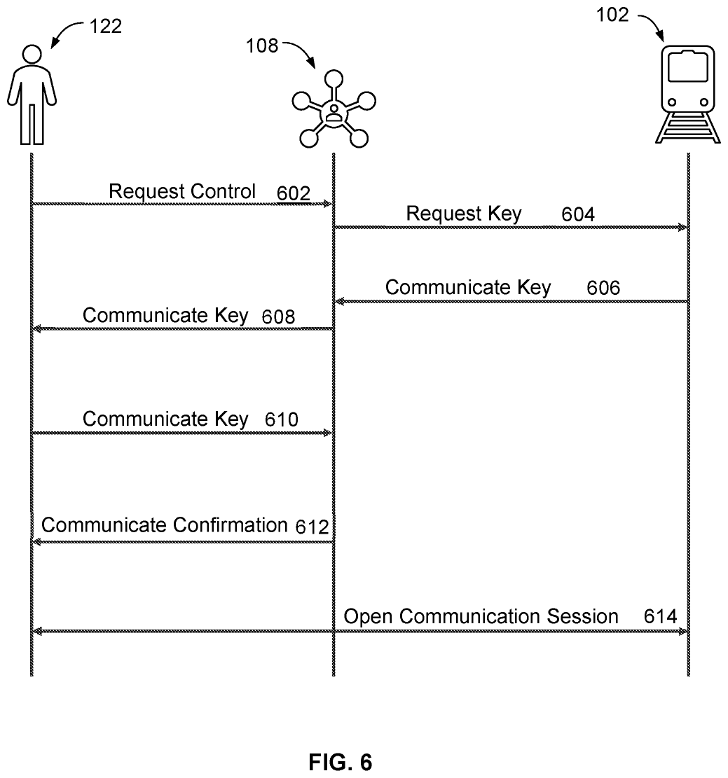

FIG. 6 illustrates a collection of communications for authenticating an operator in accordance with one or more embodiments described herein. At step 602, a candidate operator communicates a request to assume control of one or more vehicles over a first communication pathway to one or more offboard controllers. At step 604, based on receiving the candidate-operator generated request to assume control of the one or more vehicles, the offboard controller transmits a request to obtain a key from the onboard controller of at least one of the one or more vehicles. At step 606, based on receiving the request to obtain a key, the onboard controller communicates the key to the one or more offboard controllers. The key can be generated by a key generator implemented in and/or may be operably coupled to the onboard controller. Additionally or alternatively, the key can be encrypted and/or retrieved from the storage medium by the controller of the onboard controller. A suitable key can be a private key portion of a registered identity associated with a vehicle and the vehicle networks. The registered identity can include a private key portion for the vehicle or a group of vehicles and/or a private key portion for an operator. The registered identity can also include a public key associated with the registered identity that is available via a repository accessible by one or more entities associated with the vehicle network. In one example, a registered identity can include a public key containing indicia of one or more authorized operators associated with one or more vehicles or groups of vehicles that can, optionally, be related to one or more scheduled communications sessions between operators and the one or more vehicles.

Based at least in part on receiving the key, at step 608, the one or more offboard controllers communicate the key to the candidate operator over a second communication pathway that is different from the first communication pathway. At step 608, the candidate operator communicates the key back to the one or more offboard controllers via the first communication pathway. For example, the candidate controller can communicate a first private key portion received over the second communication pathway back to the one or more offboard controllers via the first communication pathway. The first private key portion can represent a private key portion associated with at least the vehicle and/or the group of vehicles. Additionally or alternatively, the candidate operator can also communicate a second private key portion associated with the identity of the candidate operator. The one or more private key portions received by the one or more offboard controllers can be used to identify, authenticate, and/or authorize the candidate operator as a confirmed operator for the one or more vehicles and, optionally, for one or more scheduled communication sessions. For example, the one or more private key portions can be used to decrypt the public key associated with the registered identity.

At step 612 and step 614, based on determining the candidate operator to be a confirmed operator, the one or more offboard controllers can communicate confirmation to the confirmed operator and/or open a communication session between the confirmed operator and the one or more vehicles. Opening a communication session between the confirmed operator and the one or more vehicles can permit the confirmed operator to control movement of the one or more vehicles. Accordingly, authenticating operators as confirmed operators may improve the security of vehicle networks by restricting access only to confirmed operators. This may reduce or avoid unauthorized and/or conflicting control of vehicles among operators, a central authority, and/or among entities associated with vehicle networks. The central authority may be, for example, a dispatch system, a controller for traffic lights, a scheduler for vehicle movements, a harbor master, or an airline control tower.

In an embodiment, a method of controlling a vehicle system (not shown) may include receiving, at an offboard controller, a request to assume control of a vehicle generated by an electronic device of a candidate operator via a first communication pathway. The method further includes the offboard controller obtaining a key from an onboard controller of the vehicle and communicating the key to the device via a second communication pathway that is different from the first communication pathway. The method also includes, with the offboard controller, determining the candidate operator to be a confirmed operator based at least in part on obtaining (e.g., receiving) the key from the device via the first communication pathway, and based also at least in part on receipt of one or more second, different authentication factors from the device (e.g., pre-established passwords, biometric data, etc.) Responsive to determining that the candidate operator is a confirmed operator, the method also includes the offboard controller coordinating establishment of a communication channel between the device and the vehicle, for the confirmed operator to control the vehicle. Before determining that the candidate operator is a confirmed operator, the method may include the offboard controller and/or the vehicle preventing the vehicle from being controlled by the candidate operator (e.g., by the device of the candidate operator).

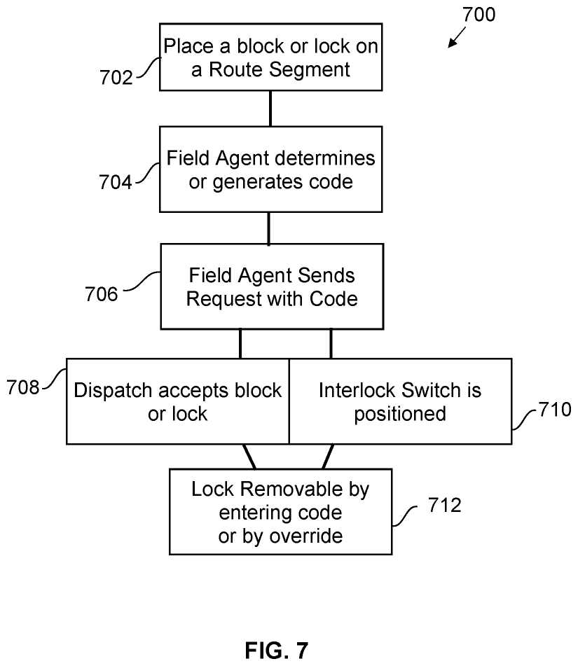

With reference to FIG. 7, a flow diagram illustrates a method 700 having embodiments according to the invention. In this scenario, when a route or section block is needed step 702, the request for a block (or lockout) originates from the Field Agent or Operator. The Field Agent choses their own code/key or can generate one from their phone app or RSA token or the like at step 704. The Field Agent or Operator may then call or communicate with dispatch and provide the code/key to the system or an operator of the system along with the request for the block or lock at step 706. The lock request may include specifics as to location, time, particular interlocks, and the like. When dispatch receives the code into the dispatcher system at step 708, the process may communicate the code to the interlock at step 710, and optionally additional parties and receive a confirmation/rejection response. In this way, the block code is generated by the field operator, and is provided to dispatch so that the route section is locked out. The dispatch system may put a lock value in a new field in a table (e.g., the “RTD Blocking view table”) or otherwise capture steps during the process. The section block record and the system prevent dispatch from unblocking the associated section of route without the code/key or an administrative override. Release of the block comes when the field-generated code is sent a second time, alone or with a “release” value from the field operator (or an administrative override is provided) at step 712.

The field operator-generated code may be static such that it is the same code in each instance from a field operator, allowing the identification of which field operator instituted a block, or may be dynamic insofar as the authentication of the field operator is managed separate from the code-creation and communication process.

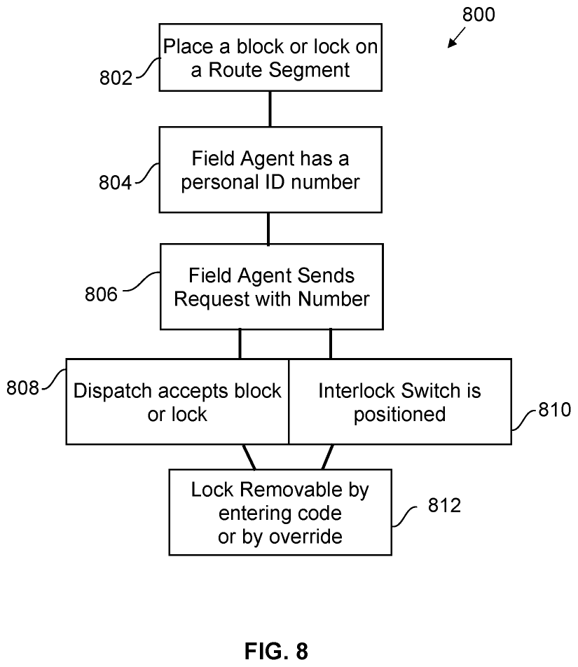

With reference to FIG. 8, a flow diagram illustrates a method 800 having an embodiment according to the invention. In this scenario, a lock value may be a combination of a known Route Section ID value (with each interlock or route section having an identified value) and a requestor number that is associable or associated with the requestor. To place a block or lock on a route section start at step 802. The field agent or requestor number is determined as the telephone number for the device from which the requestor calls at step 804. In other embodiments, the requestor number may be a MAC address of the device from which the requestor calls. Optionally, the requestor number may be a PIN pre-selected or then-selected by the requestor. Regardless, the lock value is a combination of a Route Section ID+Requestor Number. In many embodiments, each contributing value is known in advance, and may be publicly available. At step 806 the Field Agent sends a request with the requestor number. The communication may be to central dispatch, to a local node control, to a vehicle or vehicle group, or to another control system that can route vehicles (or block vehicles from a route). If to dispatch, at step 808 the dispatch accepts the block or lock request and/or at step 810 an interlock switch (or equivalent) is positioned to prevent vehicle access to the route section associated with the Route Section ID. Suitable equivalents to the interlock switch may include traffic control devices (traffic lights, cross-bucks, walk/don't walk devices, and the like). The section block record, once in place, prevents dispatch from unblocking the associated section of route. In particular, when issuing a Section Block, the system may put a lock value in a new field in a RTD Blocking view table block record that prevents dispatch from unblocking (with that value being a combination of Route Section ID and telephone number, e.g.). The system may send a confirmatory text or note to the field agent. The text may be sent via a 3rd′ party with the Route Section ID or the Route Section ID may be identified or communicated via telephone call.

When the field worker work's work is complete, the field agent may text the Route Section ID to a determined digital location, such as a telephone number, IP address, or MAC address. Dispatch may receive this information (the contents of the text and the phone number from that which sent it). If the Route Section ID and the phone number match the Blocking table record field, dispatch may remove the lock from that record. That is, the route section will be unblocked. Alternatively, the lock may be removed using an administrative override.

In another scenario, when issuing a section block, the system may put a lock value in a new field in the RTD Blocking view table block record that prevents dispatch from unblocking until the proper trigger is supplied. The field agent may be informed that a block is successfully in place and that work can begin in the designated route section. When the work is completed, the field agent will call dispatch to inform them. There will be a button or equivalent on the Block form labeled “Request Unblock”. When dispatch clicks that button, the system will communicate to a 3rd party app. The 3rd party app may push a notification to the field agent to confirm and receive confirmation/rejection from the field agent via the same 3^{rd} party app.

In another scenario, when issuing a section block, the system may provide an Internet enabled website that the field agent can access and log into from the field. The website may show a page that lists the Block(s) that have been assigned by or to the logged in field agent and that field agent can mark which Block they have completed working on. Dispatch can only unblock those route sections if marked as completed in the website or with an override command. The override command process would need separate safety protocols. The web application unlocks the block record. In one embodiment, the block record had two fields, one for the field agent and another for a supervisor.

In another embodiment, a graphical display (such as a map) indicates the route and the various blockable segments. The status of each segment may be noted (e.g., blocked/unblocked, occupied/unoccupied, health/unhealthy, communication signal strength, and the like). Selection of routes to block may be done with a GUI selection rather than, or in addition to, a Route Section ID value. Optionally, the graphical display may indicate equipment location (wayside units, switches, intersections, etc.) as well as the location(s) of field agent(s). The GPS coordinate of one or more field agents may be indicated on the map, as a function of their cell phones, for example. Also, optionally, the locations of vehicles or mobile equipment may be indicated on the graphical display. The graphical display may further include information such as: the type of work engaged by the field agent, the estimated time to completion of the work, a hazard level faced by the field agent engaged in the work, and the like.

In one embodiment, the controllers or systems described herein may have a data collection system deployed and may use machine learning to enable derivation-based learning outcomes. The controllers may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons and behavior analytics, and the like.

In one embodiment, the controllers may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

As used herein, the terms “processor” and “computer,” and related terms, e.g., “processing device,” “computing device,” and “control unit” “control system” and “controller” are not limited to just those integrated circuits but further refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in a device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify a quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

The subject matter described herein is not limited in its application to the details of construction and the arrangement of components set forth in the description herein or illustrated in the drawings hereof. The subject matter described herein is capable of other embodiments and of being practiced or of being carried out in various ways. Also, the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, in the following claims, the phrases “at least A or B”, “A and/or B”, and “one or more of A or B” (where “A” and “B” represent claim elements), are used to encompass i) A, ii) B and/or iii) both A and B.

This written description uses examples to disclose the embodiments, including the best mode, and to enable a person of ordinary skill in the art to practice the embodiments, including making and using devices or systems and performing incorporated methods. The claims define the patentable scope of the disclosure, and include other examples that occur to those of ordinary skill in the art. Such other examples are within the scope of the claims if they have structural elements that do not differ from the literal language of the claims, or if they include equivalent structural elements with insubstantial differences from the literal language of the claims.

What is claimed is:

1. A method comprising:
receiving a request to assume control of equipment generated by a candidate operator via a first communication pathway;
communicating at least a portion of a key to the candidate operator via a second communication pathway that is different from the first communication pathway, the key comprising a first key part; and
determining the candidate operator to be a confirmed operator based at least in part on obtaining the key from the candidate operator via the first communication pathway.

2. The method of claim 1, further comprising transferring control of the equipment to the confirmed operator.

3. The method of claim 1, wherein the equipment is a vehicle or a wayside unit, and the method further comprising obtaining the first key part or a second key part from the wayside unit or from an onboard controller of the vehicle.

4. The method of claim 1, further comprising opening a communication channel between a vehicle and the confirmed operator responsive to determining that the candidate operator is the confirmed operator.

5. The method of claim 1, further comprising determining the candidate operator to be a denied operator based at least in part on obtaining a different key or key part from the candidate operator via the first communication pathway.

6. The method of claim 1, wherein the first communication pathway is associated with a first type of communications network or a first type of communication protocol, and the second communication pathway is associated with a second type of communications network or a second type of communication protocol.

7. The method of claim 1, wherein determining the candidate operator to be the confirmed operator is based at least in part on one or more of an operator credential, a vehicle location, a wayside unit location, a vehicle operation schedule, an operator authority level, a security token, and biometric identification information.

8. The method of claim 1, further comprising transferring control of the equipment to the confirmed operator, and the confirmed operator thereby being enabled to initiate the equipment to perform one or more of:
switching or securing one or both of an interlock and a crossing guard to prevent or block another vehicle from entering a section of a route, where the equipment is a wayside unit;
engaging an emergency stop function to prevent the equipment from moving or from being moved, where the equipment is a vehicle, and the vehicle is or is not part of a vehicle group; and
de-energizing electrical equipment, where the equipment is an electricity providing device.

9. The method of claim 8, wherein the equipment is a wayside unit, and the method further comprising signaling a central authority that the section of the route is blocked, and the central authority does not and/or cannot direct another vehicle to enter the section of the route until the confirmed operator returns control over the equipment back to the central authority.

10. The method of claim 8, wherein the equipment is the electricity providing device and the method further comprising facilitating access to an interior of the equipment by the confirmed operator.

11. A method, comprising:
determining that a candidate operator is a confirmed operator;
transferring control of equipment to the confirmed operator responsive to the determination that the candidate operator is the confirmed operator, and the confirmed operator being therefor enabled to initiate the equipment to perform one or more of:
switching or securing one or both of an interlock and a crossing guard to prevent or block another vehicle from entering a section of a route, where the equipment is a wayside unit;
engaging an emergency stop function to prevent the equipment from moving or from being moved, where the equipment is a vehicle, and the vehicle is or is not part of a vehicle group; and
de-energizing electrical equipment, where the equipment is an electricity providing device.

12. The method of claim 11, wherein the equipment is a wayside unit, and the method further comprising signaling a central authority that the section of the route is blocked, and the central authority does not and/or cannot direct another vehicle to enter the section of the route until the confirmed operator returns control over the equipment back to the central authority.

13. The method of claim 12, further comprising returning control of the equipment to the central authority from the confirmed operator.

14. The method of claim 11, wherein the equipment is the vehicle, and the confirmed operator can control the vehicle, which is not part of a vehicle group, to prevent or block movement of that vehicle.

15. The method of claim 11, wherein the equipment is the vehicle, and the confirmed operator can control the vehicle group of which the vehicle is a part, to prevent or block movement of that vehicle group inclusive of the vehicle.

16. The method of claim 11, wherein the equipment is the electricity providing device and the method further comprising facilitating access to an interior of the equipment by the confirmed operator.

17. The method of claim 16, wherein energy providing device is disposed on a vehicle, and the confirmed operator can control the vehicle to prevent or block movement of that vehicle.

18. The method of claim 17, wherein the vehicle is part of a vehicle group, and the confirmed operator can control the vehicle group of which the vehicle is a part, to prevent or block movement of that vehicle group inclusive of the vehicle.

19. A system, comprising:
a controller configured to one or more of determine that a candidate operator is a confirmed operator or to transfer control of equipment to the confirmed operator responsive to the determination that the candidate operator is the confirmed operator, and the confirmed operator being therefor enabled to initiate the equipment to perform one or more of:
switching or securing one or both of an interlock and a crossing guard to prevent or block another vehicle from entering a section of a route, where the equipment is a wayside unit;
engaging an emergency stop function to prevent the equipment from moving or from being moved, where the equipment is a vehicle, and the vehicle is or is not part of a vehicle group; or
de-energizing electrical equipment, where the equipment is an electricity providing device.

20. The system of claim 19, wherein the equipment is a wayside unit configured to control a route switch or interlock, and the confirmed operator can configure the switch or interlock to block or prevent another vehicle from entering a section of the route.

21. The system of claim 19, wherein the equipment is the vehicle, and the confirmed operator can prevent the vehicle from moving, or the vehicle from being moved, or another vehicle from moving onto a co-located section of a route with the vehicle.
